(19) United States
(12) Patent Application Publication
(10) Pub. No.: US 2009/0191348 A1
(43) Pub. Date: Jul. 30, 2009

(54) Zone melt recrystallization for inorganic films

(76) Inventors: Henry Hieslmair, San Francisco, CA (US); Ronald J. Mosso, Fremont, CA (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 12/152,907

(22) Filed: May 16, 2008

Related U.S. Application Data
(60) Provisional application No. 61/062,420, filed on Jan. 25, 2008.

(51) Int. Cl. B05D 3/00; B01D 9/00; G01N 21/01

(52) U.S. Cl. 427/398.1; 422/245.1; 422/82.05

(57) ABSTRACT

ZMR apparatuses provide for controlled temperature flow through the system to reduce energy consumption while providing for desired crystal growth properties. The apparatus can include a cooling system to specifically remove a desired amount of heat from a melted film to facilitate crystallization. Furthermore, the apparatus can have heated walls to create a background temperature within the chamber that reduces energy use through the reduction or elimination of cooling for the chamber walls. The apparatuses and corresponding methods can be used with inorganic films directly or indirectly associated with a porous release layer that provides thermal insulation with respect to an underlying substrate. If the recrystallized film is removed from the substrate, the substrates can be reused. The methods can be used for large area silicon films with thicknesses from 2 microns to 100 microns, which are suitable for photovoltaic applications as well as electronics applications.

### CROSS REFERENCE TO RELATED APPLICATIONS

The present application claims priority to copending U.S. provisional patent application Ser. No. 61/062,420 to Hieslmair et al., filed on Jan. 25, 2008, entitled “Zone Melt Recrystallization for Thin Silicon Films,” incorporated herein by reference.

### FIELD OF THE INVENTION

The invention relates to the recystallization of inorganic films, such as silicon films. The invention further relates to apparatuses useful for the recrystallization of inorganic films as well as the corresponding processes.

### BACKGROUND OF THE INVENTION

Various approaches have been used and/or suggested for the commercial deposition of inorganic coating materials. These approaches include, for example, flame hydrolysis deposition, chemical vapor deposition, physical vapor deposition, sol-gel chemical deposition, light reactive deposition and ion implantation. In general, very slow, expensive techniques are needed to control precisely the properties of the coating materials. Techniques that produce thicker films at practical rates for many applications may generate films that can benefit from further processing after the coatings or films are formed to modify the properties of the films to more closely match desired properties.

With respect to inorganic materials, semiconductor materials are widely used commercial materials for the production of a great many electronic devices. Silicon in its elemental form is a commonly used semiconductor that is a fundamental material for integrated circuit production. Single crystal silicon is grown in cylindrical ingots that are subsequently cut into wafers. These ingots have standard sizes for integrated circuit formation. Polycrystalline silicon and amorphous silicon can be used effectively for appropriate applications. The electron mobilities and electrical properties generally depend on the cystallinity of the silicon.

### SUMMARY OF THE INVENTION

In a first aspect, the invention pertains to an apparatus for performing zone melt recrystallization of an inorganic film. The apparatus comprises a substrate support, a strip heater oriented to heat a stripe of a substrate on the substrate support, a cooling element that is oriented to cool a stripe of the substrate following heating by the strip heater, and a transport system. The transport system is configured to move the substrate support relative to the strip heater and the cooling element to scan a heated stripe across the substrate with subsequent cooling by the cooling element.

In a further aspect, the invention pertains to an apparatus for performing zone melt recrystallization of an inorganic film in which the apparatus comprising a chamber, a substrate holder within the chamber, a strip heater oriented to direct heat along a stripe of a substrate mounted on the substrate holder, and a transport system configured to move the substrate support relative to the strip heater to scan a heated stripe across the substrate surface. In some embodiments, the chamber walls are maintained at a temperature of at least 500° C.

In another aspect, the invention pertains to a method for performing zone melt recrystallization of an inorganic film in which the method comprises melting a stripe of the inorganic film and cooling the melted film. The heating is generally performed using a strip heater in which the inorganic film is located on a substrate being translated relative to the strip heater. The cooling of the melted film can comprise lowering the temperature of the film to a selected temperature below the melting point of the inorganic film downstream a distance from the heating zone following translation of the substrate.

### BRIEF DESCRIPTION OF THE DRAWINGS

FIG. 1 is a schematic sections side view of a structure comprising an inorganic film on a substrate with intermediate layers and a cap layer.

FIG. 2 is a schematic perspective view of a ZMR chamber with various improved features in which the chamber walls are depicted as transparent to provide for visualization of the inner structure.

FIG. 3 is a perspective view of a particular embodiment of an upper heating element.

FIG. 4 is a sectional side view of the upper heating element of FIG. 3.

FIG. 5 is a sectional side view of a cooling element based on an asymmetric cooling gas nozzle with a built in exhaust.

FIG. 6 is a sectional side view of a radiative cooling bar.

FIG. 7 is a sectional side view of a radiative cooling element with a cavity.

FIG. 8 is a sectional side view of a cooling roller.

FIG. 9 is a perspective view of a particular embodiment of a ZMR apparatus with portions of the chamber walls removed to expose inner portions of the chamber.

FIG. 10 is a schematic plot of the horizontal temperature profile in a cold wall chamber with relatively slow crystallization.

FIG. 11 is a schematic plot of the horizontal temperature profile in a cold wall chamber under conditions in which a supercooled region forms.

FIG. 12 is a plot of added heat to melt a silicon film and the temperature of the substrate under the melted silicon film as a function of the thermal conductivity of a porous release layer.

FIG. 13 is a schematic plot of the horizontal temperature profile in a hot wall chamber with a cooling gas system.

FIG. 14 is a schematic plot of the horizontal temperature profile in a hot wall chamber with a radiative cooling system.

### DETAILED DESCRIPTION OF THE INVENTION

As described herein, a process for zone melt recrystallization (ZMR) of inorganic films, such as silicon films, involves improved control of heat flow into and out from the film through use of a hot wall chamber and/or the use of cooling element to speed crystallization. If the walls of the chamber are heated/insulated, the thermal loss to the ambient surroundings during the ZMR process is low, so that less heat can be added by the strip heater along the silicon sheet to melt the inorganic material. After the inorganic material is melted, in some embodiments a cooling element, such as a cooling gas flow, can facilitate the removal of heat from the melted silicon to speed the solidification and crystallization process. In some embodiments, the inorganic material is located over a porous release layer that reduces heat conduction to the substrate. The control of the heat flow using hot chamber walls and/or a cooling element replaces thermal transfer through the substrate and reduces the heat lost to the substrate by conduction from the melted inorganic material, such as silicon. This re-crystallization process can be effectively used, for example, on intermediate thickness silicon foils with a thickness from 2 microns to 100 microns. The top of the layer to be re-crystallized may or may not be covered with a higher melting temperature ceramic composition as a cap.

Zone melt recrystallization involves the localized melting of a strip of inorganic material, such as silicon, with a heating element that is scanned across the surface of the material. As the heater is scanned across the surface, the melted zone cools and recrystallizes the material generally to increase the crystal size of polycrystalline silicon or other inorganic material relative to the initial crystallite size. While the thermal control principles and the apparatus designs can be adapted for the general processing of polycrystalline inorganic films based on the teachings herein, the discussion herein focuses on elemental silicon due to its importance as a commercial material. Germanium is another elemental semiconductor with similar properties as silicon, although germanium has a lower melting temperature.

To perform the zone melt recrystallization, the substrate can be heated with an appropriate conduction heater placed under the substrate to raise the temperature of the silicon nearer to its melting point such that less heat generally can be supplied from a strip heater above the film to melt the zone of the silicon. The use of a lower heater is described further in U.S. Pat. No. 5,540,183 to Deguchi et al., entitled “Zone-Melt Recrystallization of Semiconductor Materials,” incorporated herein by reference. The improved versions of zone melt recrystallization herein can be referred to as zone freeze recrystallization in which thermal control of heating and cooling is manipulated to improve processing results. This thermal control can provide for reduced energy use, shorter processing times and/or efficient processing of films significantly thermally insulated from an underlying substrate.

In traditional zone melt recrystallization, respective silicon oxide (e.g., SiO₂) layers are placed under and over the silicon layer. Since liquid silicon does not wet silicon oxide, the molten silicon would bead on the silicon oxide under layer if the silicon oxide over layer was not present. Due to the higher melting point of the silicon oxide, the silicon melts and recrystallizes within the confines of the solid silicon oxide layers. The relatively small change in volume between the liquid and crystalline silicon can be accommodated by dislocations and grain boundaries within the confines of the silicon oxide layers.

In some embodiments, a zone melt recrystallization process for silicon can be performed with a silicon layer deposited onto a silicon nitride (e.g., Si₃N₄) layer. Molten silicon can wet a silicon nitride layer so that the molten silicon is not prone to beading on the silicon nitride layer. Therefore, a high melting temperature solid ceramic layer may or may not be placed over the silicon layer. If an over-layer is used, this layer can comprise a higher melting temperature material, such as silicon oxide, silicon nitride, silicon oxynitride, silicon carbide, silicon carbonitride, combinations thereof or mixtures thereof. In alternative or additional embodiments, a silicon film can be positioned on top of a higher melt temperature material comprising silicon oxide, silicon oxynitride, silicon carbide, silicon carbonitride, combinations thereof or mixtures thereof.

In embodiments of particular interest, the inorganic films to be re-crystallized generally are relatively thin sheets, which may initially be amorphous or polycrystalline. In particular, the sheets can have an average thickness of no more than about 100 microns. The re-crystallization process can improve the nature of the polycrystalline film for some applications through the formation of larger crystals within the polycrystalline material. Silicon films with larger crystals can have improved electrical properties, such as longer carrier lifetimes. The inorganic films may or may not be doped.

For some applications, it can be desirable to be able to separate the thin film into thin foil of silicon or other inorganic material that can then be subjected to further processing. It has been found that the thin silicon film can be successfully formed onto a porous release layer. Upon the fractioning of the porous release layer, the thin inorganic foil can become a free standing structure. However, the concept of free standing refers to the transferability, and the “freestanding” structure may not actually be unsupported at any time. The term freestanding herein is given a broad interpretation that includes releasably bound structures with the ability to transfer the layer even though the “freestanding” foil may never actually be separate form a support substrate since the continual support of the foil can reduce the incidence of damage. Freestanding does not imply the film can support its own weight. Generally, the substrates can be reused after fracture of the release layer and removal of the silicon foil. The substrate surface can be cleaned to remove remnants of the release layer such that the substrates can be reused. Since the substrate can be reused, high quality substrates can be used economically.

The porous release layer can comprise essentially unfused submicron particles or a fused porous network of submicron particles deposited on a substrate. Thus, the porous release layer can be a soot from reactive deposition, which may be in the form of a fused particle network. Alternatively or additionally, the release layer can comprise a powder layer of submicron particles that are deposited from a dispersion of the particles using an appropriate coating technique with the subsequent removal of the dispersant through evaporation or the like. In some embodiments, the recrystallization process can be performed on a film in contact with a release layer between the film to be recrystallized and an underlying substrate. Generally, the porous, particulate release layer is formed from a ceramic material with an appropriate high melt temperature that does not melt during the recrystallization process. For example, for a silicon overlayer, release layers can comprise ceramics, such as silicon oxide, silicon nitride, silicon oxynitride, silicon carbide, silicon carbonitride, combinations thereof and mixtures thereof. The release layer can provide a significant amount of thermal insulation between the inorganic film undergoing recrystallization and the substrate.

In some embodiments, the inorganic sheets have a large area as well as being thin. Specifically, in some embodiments of large area, thin silicon-based semiconductor films, the structures can have an area of at least about 900 square centimeters, and in some embodiments the sheets can have areas up to 10 square meters. The large area and small thickness can be exploited in unique ways in the formation of improved devices while saving on material cost and consumption. In order to reduce the consumption of silicon (or its precursors) in the production of solar cells, thin foils of 5 to 100 microns of polycrystalline silicon can be desirable.

In general, any appropriate method can be used to form the inorganic film. One method of fabricating silicon films is to use chemical vapor deposition (CVD). CVD is a general term to describe the decomposition or other reaction of a precursor gas, e.g., silane, on the surface of a substrate. By varying temperatures and pressures at which CVD is performed, relatively uniform thin or thick films can be obtained. CVD can also be plasma enhanced.

Very thin films of crystalline silicon on the order of a few microns thick can be effectively formed with traditional CVD at high vacuum. Atmospheric pressure CVD can also be used to deposit thicker layers at reasonable rates. When performed at sub-atmospheric pressure, deposition can be better controlled to yield a more uniform thin film at a somewhat slower, although relatively rapid, rate relative to atmospheric pressure CVD. Although higher throughputs of reactants can be achieved at atmospheric pressures, high uniformity of the deposited inorganic film is achieved at sub-atmospheric pressures of about 50 Torr to about 600 Torr or a selected sub-range within this explicit range. Whether performed at atmospheric or sub-atmospheric pressure, the reactants can be directed through a nozzle as a flow with a shape determined by the nozzle opening that is directed to a moving substrate for deposition. Sub-atmospheric CVD has been developed to deposit inorganic material such as silicon using an elongated nozzle to deliver the reactant precursor composition to a substrate the moves relative to the reactant flow at a rate selected to balance the rate of the deposition process with the quality of the deposited compositions. The elongated nozzle can be shaped to direct simultaneously a stripe of reactant at the substrate.

For silicon films, CVD can be performed on a substrate at or near atmospheric pressure at high temperatures ranging from 600° C. to 1200° C. These conditions provide a high deposition rate, which is significant for films with a thickness greater than a few microns. It has been demonstrated that a CVD deposition process can be performed at sub-atmospheric pressures onto a release layer.

Another approach for the deposition of inorganic films, such as silicon, is light reactive deposition. In light reactive deposition, a light beam provides the heat to drive the reaction of the reactive flow that is oriented to flow through the light beam to produce a product flow downstream from the light beam. While a laser beam is a convenient energy source, other intense light sources can be used in light reactive deposition. The reactant composition, the reaction conditions and the deposition parameters can be selected to change composition of the coating as well as the nature of the coating with respect to density, porosity and the like.

The release layer can be deposited using a variety of techniques which provide appropriately low levels of contamination and suitably uniform layers. A porous, particulate release layer can be formed using light reactive deposition (LRD™) or through the deposition of a submicron particle coating from a dispersion. LRD deposition can results in a fused porous network of submicron particles, while the coating from a dispersed powder of submicron particles results in a coating of unfused particles.

Whether or not the porous layer comprises fused or unfused particles, in some embodiments it is desirable for the porous structure to involve submicron particles such that the surface of the porous layer has a relatively even surface such that the subsequently deposited layer or layers are relatively flat films. In general, the porous release layer can have any reasonable thickness, although it may be desirable to use a thickness that is not too large so that resources are not wasted. The release layer should comprise a sufficient thickness since the subsequent overcoat layers should not directly interact with the underlying substrate. The formation of porous, particulate release layers is described further in copending U.S. provisional patent application Ser. No. 61/062,398 to Hieslmair et al., entitled “Deposition Onto a Release Layer for the Formation of Inorganic Foils,” and published U.S. patent application 2007/0212510A to Hieslmair et al., entitled “Thin Silicon or Germanium Sheets and Photovoltaics Formed From Thin Sheets,” both of which are incorporated herein by reference.

In some embodiments, the recrystallization process is performed while the silicon film is directly or indirectly associated with the porous, release layer. In other words, the silicon film is recrystallized prior to separating the film from the release layer. One or more over layers can be deposited on the porous, particulate release layer. For example, it can be desirable to have a relatively non-porous or dense silicon nitride (Si₃N₄) layer between the silicon film and the release layer. Optionally, a cap layer or layers can be placed over the silicon, in which the cap layer can comprise a high melting temperature ceramic, such as silicon oxide, silicon nitride, silicon oxynitride, silicon carbide, silicon carbonitride, aluminum oxide Al₂O₃, blends thereof, silicon rich compositions thereof, and combinations thereof.

Suitable approaches for forming the over-layers on top of a release layer include, for example, high vacuum chemical vapor deposition, atmospheric pressure chemical vapor deposition, sub-atmospheric chemical vapor deposition, light reactive dense deposition, and combinations thereof, e.g., different layers can be deposited using different methods. For example, a porous release layer can be deposited using light reactive deposition and one or more over-layers can be deposited using sub-atmospheric CVD. A single reaction chamber can be used to perform depositions based on multiple techniques, such as light reactive deposition and sub-atmospheric scanning CVD.

The apparatus for performing the zone melt recrystallization generally comprises a chamber, a strip heat source, a substrate support to hold the inorganic film and associated structure, and a transport system to provide relative movement of the inorganic film and the strip heater. The transport system can move the support relative to the chamber, the strip heater relative to the chamber or both. The apparatus optionally also can comprise a cooling element to remove heat from the melted silicon to facilitate the recrystallization process. Suitable cooling elements include, for example, a radiation heat sink, a cooled roller and/or a cool gas source, such as an asymmetrically exhausted linear nozzle to provide a stream of cool inlet gas on the solidification side of the heat zone. Also, in some embodiments, the chamber walls are controlled to be within a selected temperature range, which can be accomplished through heating the walls and/or through insulation of the walls. The selected temperature range surrounding the substrate within the recrystallization chamber can be within about 900 degrees C. or a few degrees C. below the melting temperature of the inorganic film, as selected for the particular process. The chamber may or may not be effectively isolated from the ambient atmosphere surrounding the chamber. If the silicon film does not have a capping layer, it is generally desirable to control the gas environment in the chamber to correspondingly control any reaction of the surface of the silicon with the gas in the chamber.

The substrate support generally can be any appropriate platform to hold the inorganic film and associated structure at the temperatures of the chamber. In some embodiments, the support can be integrated with a conveyor or other component of the transport system if the conveyor is designed to move the support relative to the chamber. For example, the transport system can comprise a conveyor belt or a stage or platform that is connected with an appropriate moving element. The conveyor can be appropriately constructed to move the support and/or the linear heater.

Generally, the line of radiant heat from the linear heat source can be moved or swept across the film to provide a thin stripe as a heat zone across the film. This configuration creates a molten zone of silicon at the heat zone that spreads to some degree through conduction somewhat beyond the irradiation zone and the melted zone of inorganic material is transported downstream relative to the heat zone. As the heater and film move relative to each other, the molten wave front cools as it gets further from the heat zone, and upon sufficient cooling the silicon crystallizes. The speed of the crystallization influences the properties of the product recrystallized silicon.

As described herein, a hot wall chamber can be effectively used for desirable results, although a cold wall chamber can be used in alternative embodiments. A hot wall chamber can be particularly desirable for embodiments in which the silicon film is associated with a porous release layer. A wall of the chamber can include a thermocouple or temperature regulator, and the temperature of the chamber walls or a portion thereof generally can be set to a temperature from about 400° C. to about 1400° C., although the particular selected temperature generally is influenced by the composition of the inorganic film. As described further below, the chamber can have a cooling element configured to remove heat from the film downstream from the heater to better control the cooling process.

For economic and manufacturing reasons, it can be desirable to move the linear heat source or sweep the heat zone across the film at a relatively high speed. At high enough ZMR velocities, however, the resulting solidified silicon film can have inferior qualities relative to films recrystallized at lower speeds. Specifically, the size of the crystal grains can decrease, and the density of crystal defects can increase. Therefore, it is desirable to select a speed that balances the ZMR velocity while producing reasonable crystal quality. This determination of balance involves an investigation of the limiting variables that limits improvements in ZMR velocity, crystal quality, or both. The relevant variables include, for example, the rate at which liquid silicon atoms arrange into a crystal and the rate at which heat can be removed from the silicon solidification front without causing significant thermal strain that can induce crystal defects.

The rate at which liquid silicon atoms arrange into a crystal provides a physical limit on the process. The ZMR velocity can still be improved without sacrificing crystal quality below desired limits if the other appropriate variables can be adjusted without reaching a limit imposed by the atomic scale dynamics of the crystallization process. In particular, it is noted that the heat of solidification is about 1800 J/g and the heat capacity is about 1 J/gC. In such a case, improved heat removal from the solidification front can be devised through adjusting heat removal from each of the heat dissipation paths, which include, for example, radiation from the surface of the film, natural gas convection in the chamber, and heat conduction into the substrate.

While a primary application of interest is the manufacture of solar cells, other applications include, for example, flat panel displays. In particular, the semiconductor sheet can be a substrate for the formation of thin film transistors and/or other integrated circuit components. Thus, the thin semiconductor sheets can be large format display circuits with one or more transistor associated with each pixel. The resulting circuits can replace structures formed by silicon on glass processes. The sheet can be patterned to form transistor or other circuit structures. The formation of display components from large area semiconductor foils is described further in published U.S. patent application 2007/0212510 A to Hieslmair et al., entitled “Thin Silicon or Germanium Sheets and Photovoltaics Formed From Thin Sheets,” incorporated herein by reference.

The zone melt recystallization approaches described herein provide for desirable processing for thin inorganic films in the thickness ranges of particular interest, especially when the films are associated with a release layer. The apparatus and processes are adaptable for automated processing within an integrated system for handling a continuously produced series of films along a production line. The processes can have a desirable level of energy efficiency as well as speed of production.

### Properties and Formation of Inorganic Films and Corresponding Structures

The inorganic film that is recrystallized generally is associated with an inorganic structure in which the film forms a layer within the structure. The overall structure provides an assembly that can be handled conveniently without damaging the film. The film can be incorporated into the structure as a permanent layer within the structure or as a releasably supported foil on the substrate. In some embodiments, the film is directed or indirectly associated with a release layer that is mechanically weak such that the film can be separated as a foil following zone melt recrystallization. Reactive deposition approaches can be conveniently used to form the film and, optionally, some of the other layers within the structure. In some applications of zone melt recrystallization for silicon, the silicon is sandwiched between two ceramic layers. The ceramic materials have a higher melting point than silicon so that the silicon layer melts between the ceramic layers and subsequently solidifies within the ceramic layer boundaries. The top ceramic layer constrains the molten silicon from beading up or otherwise distorting significantly from a planar layer as a result of surface tension or other effects.

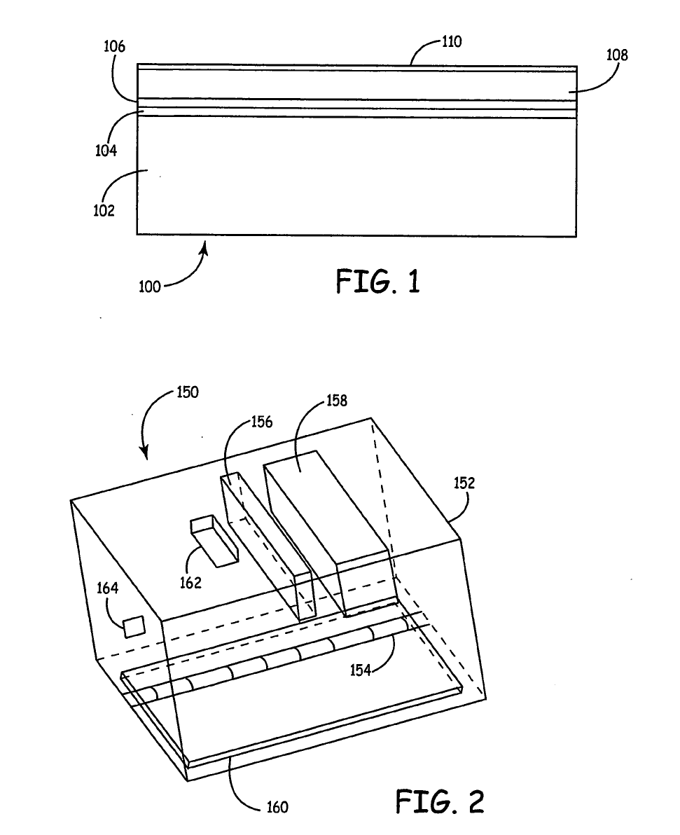

An inorganic structure for ZMR processing comprises a substrate, the film, one or more optional intermediate layers, and one or more optional capping layers. A schematic diagram of an embodiment of an inorganic structure 100 is shown in FIG. 1. Structure 100 comprises a substrate 102, a release layer 104, an under-layer 106, inorganic film 108 and cap layer 110. Substrate 102 generally provides mechanical stability to the structure during handling. In general, the substrate can have a composition such that the substrate does not melt or get significantly damaged from thermal stresses during the zone melt recrystallization process. If the substrate is permanently incorporated into the structure, the properties of the substrate can be selected appropriately for the ultimate application of the inorganic structure. For embodiments in which the film is subsequently separated at a release layer to form an inorganic foil, the substrate can be reused. For the processing of silicon foils, a silicon substrate can be appropriate, although suitable high melting ceramics can similarly be used. High quality ceramic substrates can be used without incurring undesirably large costs due to the ability to clean and reuse the substrate after the foil is separated from the substrate for transfer to a structure for additional processing into a product. Suitable substrates can be smooth silicon surfaces, ceramic surfaces such as silica glasses. In some embodiments, the substrate can be a flexible material. For example, flexible ceramic sheets are available that can withstand high temperatures. For example, Nextel™ woven ceramic fabrics from 3M or SigraBond® carbon materials from SGL Carbon AG (SGL Group) can be used as substrates.

A release layer has a property and/or composition that distinguish the release layer from adjacent materials. Generally, the property of the release layer provides for the separation of the release layer from one or both of its adjoining materials. Suitable physical properties of a release layer can be, for example, low density, high melting/softening point, low mechanical strength, large coefficient of thermal expansion or combinations thereof. In addition, the material of the release layer generally should be inert with respect to the other materials at conditions of relevant processing steps, such as at high temperature, in some embodiments. For the mechanical fracturing of the release layer, generally it is desirable for the release layer to have a lower density than the surrounding materials. In particular, the release layer can have a porosity of at least about 40 percent, in some embodiments at least about 45 percent and in further embodiments from about 50 to about 90 percent porosity. A person of ordinary skill in the art will recognize that additional ranges of porosity within the explicit ranges above are contemplated and are within the present disclosure. Porosity is evaluated from a SEM micrograph of a cross section of the structure in which the area of the pores is divided by the total area. For silicon films, suitable materials for a release layer for silicon include, for example, silicon nitride (Si₃N₄) or silicon rich silicon oxide (SiOₓ, x<2).

Under-layer 106 can function as a dense buffer between the film and the release layer during the recrystallization process. Furthermore, the under-layer can form a functional layer in the ultimate device incorporating the recrystallized film. Cap layer 110 functions as the top ceramic layer. Liquid silicon generally has a large contact angle when wetting on silicon dioxide and some other ceramic materials such that the liquid silicon beads. If the liquid silicon beads, it will not cool into a polycrystalline planar layer such that a cap layer can be appropriately used to constrain the molten silicon in a planar configuration. Molten silicon wets on silicon nitride with a low contact angle. Thus, in appropriate embodiments, the molten silicon on silicon nitride can reasonably maintain a flat surface without a top ceramic layer constraining the molten silicon.

Thus, a cap layer to restrain the liquid silicon may or may not be used. Even if surface tension and surface interactions provide for wetting that avoids beading of the liquid, there may be other effects that can move the liquid silicon in undesirable ways, such as convection or thermocapillary effects. A thin cap layer could be formed in-situ with cooling gas bearing oxygen and/or nitrogen that forms a skin of a corresponding oxide, nitride or oxynitride.

For photovoltaic applications, a top and bottom passivation layers on the respective sides of the silicon layer function to provide an electrically insulating layer as well as protection from mechanical and chemical damage. Under-layer 106 and a cap layer 110 may be incorporated as passivation layers in a device formed from the inorganic film. Suitable materials to form passivation layers include, for example, stoichiometric and non stoichiometric silicon oxides, silicon nitrides, and silicon oxynitrides, with or without hydrogen additions. Specifically, passivation layers can comprise, for example, SiNₓO_{y}, x≦4/3 and y≦2, silicon oxide (SiO₂), silicon nitride (Si₃N₄), silicon rich oxide (SiOₓ, x<2), or silicon rich nitride (SiNₓ, x<4/3). It has been found that a front aluminum oxide passivation layer can improve the efficiency of a silicon-based solar cell by a significant amount through the reduction of energy losses at the surface. The passivation layers generally can have a thickness generally from about 10 nanometers (nm) to about 200 nm and in further embodiments from about 20 nm to about 180 nm and in further embodiments from about 30 nm to about 150 nm. A front passivation layer in a photovoltaic cell can further function as an antireflective coating. A person of ordinary skill in the art will recognize that additional ranges of thicknesses within the explicit ranges above are contemplated and are within the present disclosure.

Furthermore, in some embodiments, the thin silicon semiconductor films can have a thickness of at least about 2 microns, in some embodiments from about 3 microns to about 100 microns, and in other embodiments the silicon films have a thickness from about 5 microns to about 50 microns. A person of ordinary skill in the art will recognize that additional ranges of area and thickness within the explicit ranges above are contemplated and are within the present disclosure.

In general, any suitable approach can be used to form the inorganic structures. A copending patent application describes the use of light reactive deposition to form a polycrystalline silicon layer over a porous layer that is also formed by light reactive deposition. This copending patent application has published as US 2007/0212510, filed Mar. 13, 2007 to Hieslmair et al., entitled “Thin Silicon or Germanium Sheets and Photovoltaics Formed From Thin Sheets,” incorporated herein by references. Similarly, in the process described in this published patent application, the porous, particulate release layer can be also formed by light reactive deposition. LRD deposition is described further in published U.S. patent application 2003/0228415A, to Bi et al., entitled “Coating Formation by Reactive Deposition,” incorporated herein by reference. Light reactive deposition can be used to deposit a wide range of inorganic compositions, including compositions that are suitable for zone melt recrystallization.

CVD deposition onto porous, particulate release layers is described further in copending U.S. provisional patent application 60/934,793 filed Jun. 15, 2007 to Hieslmair et al., entitled “Sub-Atmospheric Pressure CVD,” and copending U.S. provisional patent application Ser. No. 61/062,398, filed on Jan. 25, 2008 to Hieslmair et al., entitled “Deposition Onto a Release Layer for the Formation of Inorganic Foils,” both of which are incorporated herein by reference. The recited provisional patent applications teach that atmospheric pressure CVD and sub-atmospheric pressure CVD can be performed within a light reactive deposition chamber with the light source turned off to form silicon films and other inorganic films.

### ZMR Apparatus

The ZMR apparatus comprises a chamber configured with appropriate substrate handing systems and components to control thermal flow delivered with respect to the film undergoing recrystallization. Suitable measurement devices can provide feedback for the thermal control systems. In particular, in some embodiments, a hot wall chamber provides a higher background chamber temperature that reduces the heat that needs to be added to the film for melting. In additional or alternative embodiments, a cooling element can control the cooling of the melted film such that the crystallization process can be performed under more controlled conditions. In some embodiments, the film is recrystallized within a structure having a porous release layer that provides thermal insulation from the substrate. With an insulating release layer, the substrate does not need to be heated to as hot of a temperature relative to the melting point of the film. Heaters can be used that provide laterally varying heat input to provide more even temperature across the film surface. These individual improved features can be provided individually, or they can be combined in a selected combination, such as including all of the improved features, for effective recrystallization with improved thermal control.

A ZMR apparatus is shown schematically in FIG. 2 with a set of improved features as described herein, although alternative embodiments may have only 1 or a subset of the features, as desired. ZMR apparatus 150 comprises a hot wall chamber 152, a conveyor system 154, an upper heating element 156, a cooling element 158, a bottom heater 160, an optical measuring device 162, and a temperature sensor 164. Hot wall chamber 152 comprises side walls, front wall, rear wall, top and bottom that can be individually insulated and/or heated. In particular, the chamber can be insulated to reduce the waste of heat from the heated chamber. Distinct bottom heater 160 is shown in FIG. 2. Bottom heater 160 can be a ceramic heater, such as a boron nitride heater, or other suitable device. The optional bottom heater source can also be incorporated into the support platform, although this may be not desirable for embodiments in which the silicon is positioned on a porous release layer since the porous release layer may not conduct heat effectively.

If the silicon film does not have a capping layer, it is generally desirable to control the environment in the chamber to correspondingly control any reaction of the surface of the silicon with the gas in the chamber. In some embodiments, the chamber is filled with inert gas, such as argon. Closed chambers can be constructed from various durable materials, such as metals and ceramics. For hot wall chambers, the walls can comprise a refractory material, and the walls can have a multilayered construction. The inward facing surface of the chamber walls generally should be inert to the atmosphere if the chamber at the processing temperature while also not emitting atoms that can be contaminants. Suitable inert refractory materials can include silicon carbide, silicon nitride and the like. The inward facing surface can comprise a non-refractory material, such as fused quartz, for some temperatures and atmospheres. Fused quartz can be a desirable material if the chamber is not free of oxygen such that the quartz can supply an inert durable material. The material behind the inert inward facing layer can be an inert, refractory material with a high insulating value, such as high alumina refractory brick, silica aero gels, silica fiber material, such as used in space shuttle tiles, and the like. Similar materials have been used in industrial furnaces, such as glass furnaces. If the walls are heated, the heating elements can be placed, for example, between the inert, refractory inner material and the highly thermally insulating refractory layer. The walls may or may not be reflective of light from the inside of the chamber. Additional wall layers can be used if desired. In some embodiments, the chamber walls can be heated to supply a background temperature relative to which the heating and cooling processes of the recrystallization can take place, although highly insulated walls can facilitate maintaining the inner chamber temperature within a reasonable background range based on retaining the heat generated by the recrystallization process during a continuous or regular processing system without heaters built into the walls.

In some embodiments, resistive heaters or the like can be incorporated into the chamber walls to supply heating to the chamber walls. Alternatively or additionally, a well insulated chamber wall can be designed to retain heat from the zone melting process such that direct heating of the walls may or may not be used. In some embodiments, the walls can comprise a heater and a temperature sensor such that the walls can be initially heated, and then the heaters can be turned off or only operated a small amount of input power to maintain the walls at a desired temperature.

Conveyor system 154 comprises a suitable drive, such as a chain drive or the like that engages with a substrate holder to laterally transport the substrate holder with the substrate through the chamber. The motor to power the drive can be placed outside of the chamber 152 such that the motor can operate under lower temperature conditions with a portion of the drive engaging the motor.

Upper heating element 156 can be a focused halogen or xenon lamp, an inductive heater, carbon strip heater, rastered laser, or the like. The focusing of a tungsten-halogen lamp for zone melt recrystallization is described further in an article to Choi et al., Journal of Electronic Materials, 20 (3) pp 231-235, entitled “Zone Melt Recrysallization of Polysilicon by a Focused Lamp with Unsymmetric Trapezoidal Power Distribution,” incorporated herein by reference. The use of a specially designed carbon strip heater is described in U.S. Pat. No. 5,540,183 to Deguchi et al., entitled “Zone-Melting Recrystallization of Semiconductor Materials,” incorporated herein by reference. An appropriate linear reflector with a parabolic cross section can be used to reflect and focus light on the surface to melt the silicon. In alternative or additional embodiments, upper heating element 156 can comprise a diode array, which can be a laser diode array.

In general, it is desirable for upper heating element 156 to heat a narrow stripe of the film uniformly. The heated area is desired to be narrow so that the melted zone can be correspondingly reduced. It is desirable for the heating to be relatively uniform along the stripe so that excess heat is not added to the system to ensure the melting of the cooler regions. In some embodiments, upper heating element 156 can be designed to provide more heat toward the ends of the strip relative to the center of the strip such that the stripe of the film is heated more uniformly based on the expected temperature profile in the ZMR chamber. With a diode array, the power to the individual diodes can be adjusted to yield the desired increased heat emission from the ends of the array. In other embodiments, a carbon strip heater can be constructed with a larger number of turns of the wire powering the heater placed toward the ends of the strip heater relative to the number of turns near the center of the heater.

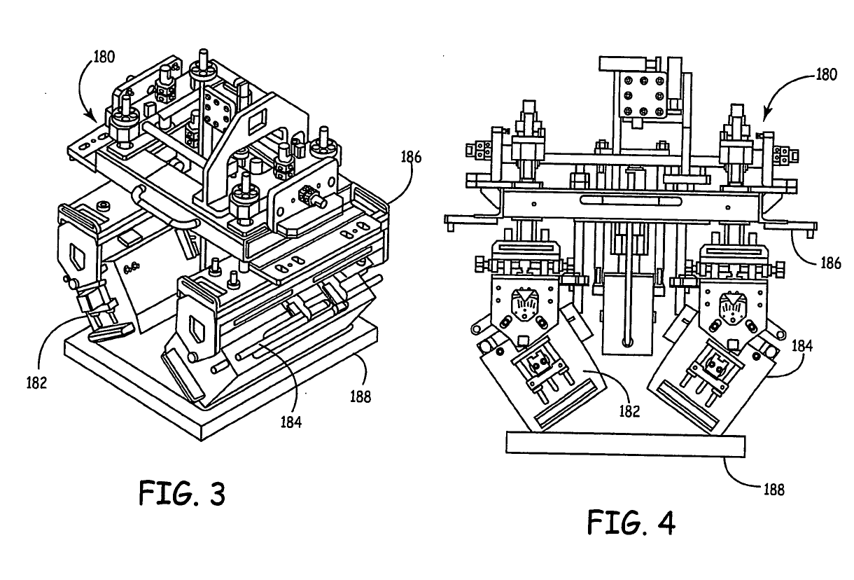

A particular embodiment of an upper heating element is shown in FIGS. 3 and 4. Upper heating element 180 comprises angled carbon strip heaters 182, 184 mounted on support frame 186 with a quartz window separating the lamps from the other portions of the ZMR chamber. Carbon strip heaters 182, 184 are each designed to produce a narrow strip of light. Strip heaters 182, 184 can be angled such that their respective light emissions are directed to the substrate at an approximately overlapping area. Support frame 186 can comprise adjustments for the angles of strip heaters 182, 184, the height relative to the substrate and the lateral positioning of the strip heaters 182, 184 along the plane of the substrate.

Cooling element 158 can comprise, for example, a cooling gas inlet, a conductive cooling contact and/or a black body radiative heat sink. Generally, cooling element 158 can have a strip configuration analogous to the strip heaters, such that the cooling element removes heat from a melted stripe of the film following its passage through the melt zone. The degree of cooling can be adjusted to lower the temperature of the stripe of the film to speed crystallization and to make the crystallization process more uniform. The speed also can be adjusted to yield desired properties of the crystallized film. In some embodiments, the relative position of upper heating element 156 and cooling element 158 can be adjusted to correspondingly alter the properties of the crystallized film.

Referring to FIG. 5, a schematic sectional view is shown of a cooling gas system. Cooling gas system 190 comprises a cooling gas inlet 192 operably connected to a cooling gas reservoir 194, and an exhaust 196 operably connected to a pump 198, blower or other gas flow element. Cooling gas system 190 is configured to remove the cooling gas into exhaust 196 after the cooling gas has interacted with the film structure so that the chamber is not cooled further. The cooling gas is not necessary cool relative to room temperatures, but the cooling gas should be cool relative to the chamber temperatures. Furthermore, the temperature of the gas can be selected so that undesirable thermal stresses are not introduced into the material upon cooling. Generally, the cooling gas comprises an inert gas, such as argon or the like. With suitable cap layers, a broader range of gases can be inert with respect to the structure. In some embodiments, the cooling gas can comprise of oxygen and/or nitrogen that forms a thin capping layer of oxide, nitride or oxynitride on the silicon, although these gases can be inert if a cap layer is already present.

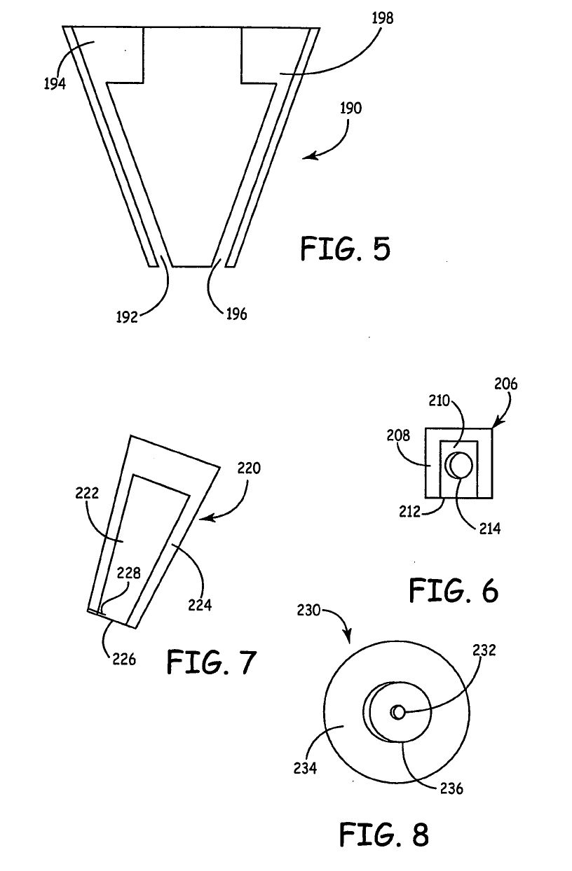

Referring to FIG. 6, a schematic sectional view is shown of a radiative cooling bar 206. The radiative cooling bar can comprise an insulating jacket 208 to reduce heating from the chamber background temperature, a block 210, a cooling surface 212 generally having a non-reflective surface, and a cooling coil 214 or the like. Block 210 can be constructed of a metal or the like to provide an appropriate heat capacity with a reasonable thermal conductivity that provides for the cooling function without large temperature fluctuations. Cooling coil or the like can provide for the circulation of a cooling fluid to remove heat that is absorbed by cooling bar 206. Cooling bar 206 can be positioned close to the structure's surface just above the film or cap layer so that the heat can be efficiently removed with less cooling of the chamber background.

Referring to FIG. 7, a schematic sectional view is shown of a radiative heat sink. In this embodiment, radiative heat sink 220 comprises an inner volume 222 surrounded by cooled walls 224. Window 226 covers volume 222 so that the chamber is not convectively cooled by the cooled walls. Window 226 can be aimed to receive radiation from the stripe of the film to be cooled. The size of the opening into inner volume 222 through window 226 can be adjustable through the use of a shutter 228 or the like so that the degree of radiative cooling can be similarly adjusted. The walls can be cooled with a suitable liquid or other appropriate cooling approach. Again, the cooling is directed to suitable temperatures below the chamber temperature.

A contact cooling device can be used to remove heat from the film through conduction from the film or cap, if present. Generally, this is most appropriate when a cap layer provides a solid surface to provide for contact without disrupting the liquid of the melted film. A roller is appropriate since a roller can interfere less with the movement of the substrate through the apparatus. Referring to FIG. 8, cooling roller 230 comprises an axel 232, a conductive roller material 234 and a cooling coil or the like. The conductive roller material can be a ceramic material or other suitable material that can tolerate the temperatures of the structure. The material should have a reasonably high heat capacity and/or thermal conductivity such that it can be effective to remove heat from the film. Cooling coil 236 can have circulating fluid to remove heat absorbed by the roller in use. Cooling coil 236 can connect to a cooling liquid source through the axel on one end of the roller or though an alternative appropriate connection.

Optical measuring device 162 can comprise, for example, a charge-coupled device (CCD) camera or the like. The optical measuring device can be used to estimate the temperature of the film, near and/or at the melt zone based on the optical emissions from the film and associated structure from the top surface. The optical measuring device can have a detection array to measure the optical emissions for temperature estimates laterally along the film. High resolution CCD cameras are commercially available. The measurements of the optical measuring device can be used to control the upper heating element and or other elements of the thermal control system. The use of a CCD camera to facilitate a ZMR process is described in Kawama et al., “In-Situ Control in Zone-Melting Recrystallization Process for Formation of High-Quality Thin Film Polycrystalline Si,” in Proceedings of the 25th IEEE Photovoltaic Specialists Conference, Washington, D.C., p. 481-484 (1996), and in Yokoyama et al., “Fabrication of SOI Films with High Crystal Uniformity by High-Speed-Zone-Melting-Crystallization,” J. of the Electrochemical Society, 150(5) A594-A600 (2003), both of which are incorporated herein by reference.

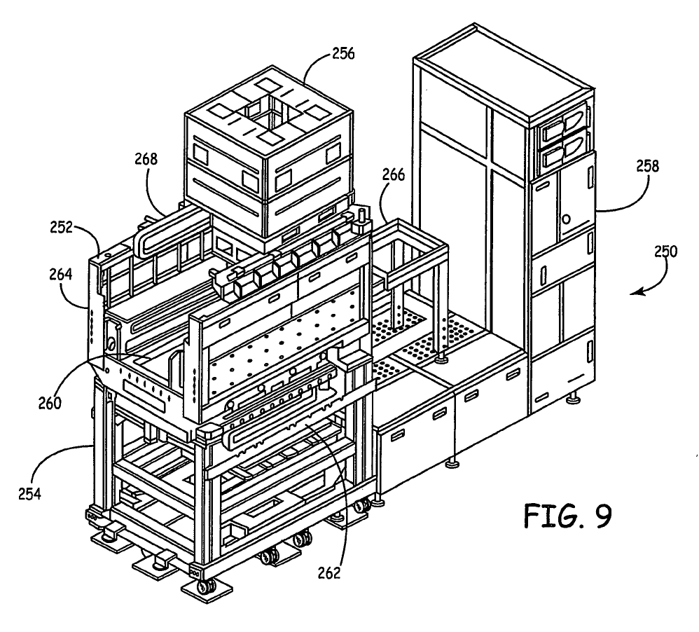

A particular embodiment of a ZMR apparatus is shown in FIG. 9. ZMR apparatus 250 comprises chamber 252, shown partially removed for visualization, support frame 254, upper heating element 256 and controller 258. Chamber 252 comprises a transport unit 260 for conveying a substrate, a bottom heater 262 and insulated walls 264, 266. Upper heating unit 256 comprises a conveyer system 268 for adjusting the relative position relative to chamber 252.

### Thermal Control of the Zone Melt Recrystallization Process

The apparatuses described above can be adapted for effective zone melt recrystallization processing. In particular, for silicon film embodiments the ultimate objectives are to form a silicon film with desirable electrical properties generally associated with larger crystal size and/or improved crystallinity with fewer defects. Comparable objectives would be relevant for other inorganic films. In some embodiments, an inorganic over-layer deposited onto a porous, particulate release layer can be subjected to the zone melt recrystallization process. The porous release layer separating the film from the underlying substrate creates a significant thermal barrier between the film and the substrate. Achieving desired crystallinity properties can be especially challenging for thicker films. Furthermore, it is desirable to keep the energy consumption low and the processing rate relatively high. Significant energy savings can be achieved through the thermal isolation of the ZMR chamber that avoids cooling the chamber.

Through the use of a hot wall chamber, the thermal background remains relatively fixed within the chamber. The film recrystallization then is controlled during the recrystallization process through heating and cooling around this thermal background. Since the chamber background temperature heats the film prior to entry into the melt zone, the film does not rely on heating through the substrate using a lower heater that would involve thermal conduction from the substrate, which can be inhibited by the presence of a porous layer. With heat being supplied from a strip heater or the like, a cooling element can control the cooling process to drive the crystallization since radiation cooling is reduced within the hot wall chamber. In cold wall chambers, radiative cooling can help to drive the cooling needed to lower the temperature to the freezing point of the silicon.

In some embodiments, the inorganic film can be located on a substrate with a release layer between the inorganic layer and the substrate along with an optional additional layer or layers between the release layer and the inorganic film. Since a porous, particulate release layer can to some degree thermally isolate the inorganic layer from the substrate, the thermal isolation limits the effectiveness of heating of the inorganic film with a lower heater located in the support, and similarly, the thermal isolation limits the conductive cooling of the melted silicon through conduction of heat to the substrate. Also, a thermocouple or other temperature measuring device in the support may not accurately reflect the temperature of the inorganic material due to the presence of the thermally insulating layer. In some embodiments, the insulating effect of the release layer can be used advantageously since the substrate is not effectively heated by the molten material, and this substrate heat is generally lost during subsequent processing. The release layer also can aid in relief of strain due to thermal expansion differences within the structure. The use of a release layer provides for the formation of freestanding foils comprising the recrystallized silicon or other inorganic composition that can be advantageously processed into solar cells or other devices.

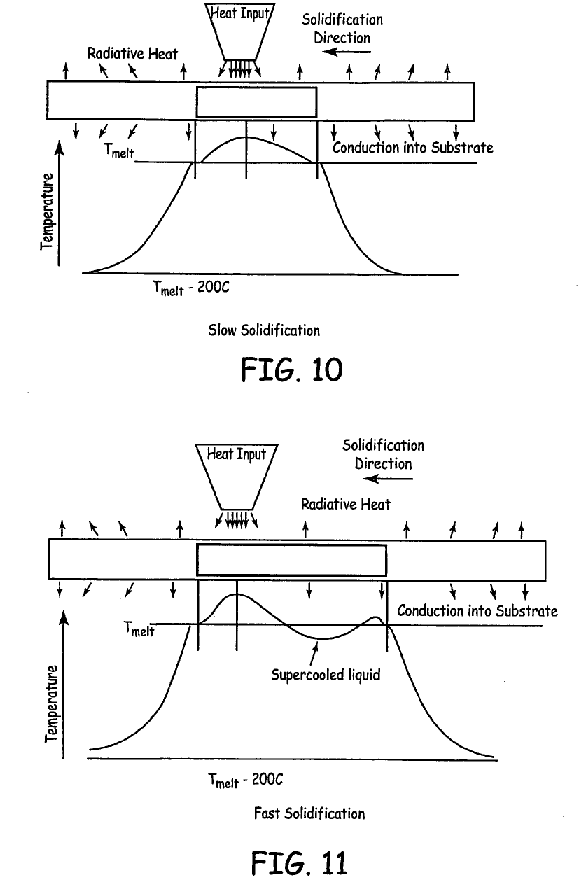

FIG. 10 shows a qualitative schematic plot constructed of the temperature profiles in ZMR using a cold wall chamber without an insulating porous release layer with arrows showing the direction of heat dissipation. As shown in FIG. 10, horizontal temperature gradients in inorganic film indicate the removal of the heat of solidification with relatively slow cooling. As the molten material is moved away from heating zone, the film cools through all of the available cooling pathways. Due to the latent heat of melting, the temperature profile exhibits flats at the melt and solidification interfaces where phase transitions are occurring. Heat can be radiated outward into the furnace ambient space and conducted downward into the cooler substrate. If the chamber has cool walls, heat is dissipated more quickly through radiative cooling relative to corresponding hot wall chambers. Since solid silicon has relatively high heat conduction (4.5×) compared to SiO₂, heat flows from the solidification front through the newly solidified silicon and then across the SiO₂ into the ambient gas through a capping layer or into the substrate through an under-layer. The width of the molten zone along the scanning direction for most reasonable configurations can be about 1 mm to about 5 mm.

As the solidification front moves, the heat of melting is removed from the interface as additional silicon solidifies into crystalline silicon and the solid/melt interface correspondingly propagates. The solidification lags behind the heat input zone with a distance related to the rate of cooling and the crystallization rate. If a larger distance develops between the solidification front and the linear heat input, it becomes more difficult to control and maintain a linear solidification front, and this may result in a decrease in the uniformity of the resulting recrystallized film.

Cooler substrates help to reduce the distance between the heat zone and the solidification front in embodiments with higher thermal conductivity between the film and the substrate. However, if cooler substrates are used, the upper heating element then correspondingly adds a larger amount of heat to melt the film. If the speed of the substrate is increased through the apparatus, heat must be removed more quickly at the solidification front, which can result in correspondingly larger thermal stress due to a corresponding increase in the thermal gradients. The newly solidified silicon is soft, and the thermal stress can induce an increase in crystal defects and dislocation densities. To reduce the thermal gradient, the substrate temperatures can be increased, but then the distance between the heat input and the solidification front increases with a corresponding difficulty on controlling the position and flatness of the solidification front.

At higher solidification rates and/or larger film thicknesses, a supercooled liquid can form between the solidification front and the heat zone if the removal of heat at the solidification front becomes rate limiting with respect to the crystallization process. The temperature gradient with more rapid cooling is plotted schematically in FIG. 11. The formation of the supercooled liquid can create significant instabilities since the solidification front can be shifted further back from the heat zone and since the any perturbation in the solidification front can break through and rapidly solidify the supercooled liquid.

In some embodiments, if the chamber walls are cold and a substrate support is used to heat the substrate, the substrate temperature can be, for example, from about 600° C. below the film melting temperature to a temperature close to the melting temperatures. Thus, for silicon films, the substrate can be heated to temperatures from 900° C. to about 1300° C. The melting temperature of silicon is about 1410° C. In these embodiments, the horizontal thermal gradients in the solidified silicon near the melt zone appear to be greater than about 20 C/mm and can be about 30 C/mm under some conditions. Thus, within 1 cm of the solid-liquid interface, the temperature drop can be several hundred degrees, which causes a contraction of up to 0.1% in volume. This volume contraction can be accommodated, because of the plasticity of silicon at these temperatures, although these large thermal gradients can result in crystal defects, such as dislocations and grain boundaries, of the silicon crystals. The control of the width of the melt zone by adjusting the heat added can be assisted with measurements with a CCD camera as described in an article by Kawama et al., IEEE Proceedings-25th PVSC, May 13-17, 1996, pp 481-484, entitled “In-Situ Control in Zone-Melting Recrystallization Process for Formation of High-Quality Thin Film Polycrystalline Si,” incorporated herein by reference. The effect of scanning speed on the recrystallization process for a cold wall chamber is described further in an article to Yoon, et al., J. Appl. Phys. 72 (1), pp 316-318 (Jul. 1, 1992), entitled “Effect of Scanning Speed on the Stability of the Solidification Interface During Zone-Melt Recrystallization of Thin Films,” incorporated herein by reference. The effects of varying the substrate temperature in cold wall ZMR processing is discussed in an article by Kieliba et al., “Enhanced Zone-Melting Recrystallization for Crystalline Silicon Thin-Film Solar Cells, 16th European Photovoltaic Energy Conference, Glasgow 1-5 May 2000, p. 1-4.

A suitable ZMR velocity appears to be dependent on silicon film thickness. If the silicon film is thicker, a slower ZMR velocity seems to achieve a comparable defect concentration as achieved in a thinner film recrystallized at a faster rate. This observation fits well with the qualitative model shown in FIG. 10. More joules are removed from the solidification front of a thicker silicon film than a thin film to achieve crystallization. To achieve crystallization on similar time frames, the rate of dissipating heat is correspondingly larger for a thicker film. Yet, the heat dissipation paths (i.e. radiative cooling and heat conduction into the substrate) remain the same as with a thin film. Measurements have been made of defect density as a function of silicon film thickness and scanning speed of the substrate through the apparatus. It is observed that for thicker films, a slower scanning speed was used to obtain the same defect densities measured in thinner films. See, Kawama et al., IEEE Proceedings-25th PVSC, May 13-17, 1996, pp 481-484, entitled “In-Situ Control in Zone-Melting Recrystallization Process for Formation of High-Quality Thin Film Polycrystalline Si,” incorporated herein by reference.

An analysis of the temperature profile for a cold wall chamber as illustrated in FIG. 10 has revealed that heat dissipation can be improved through appropriate changes in the process. Specifically, this improved heat dissipation can be accomplished by using one or more features of a hot wall chamber with a cooling element for controlled cooling on the solidification side of the heat zone, along with a porous release layer to reduce heat conductance into the substrate. In some embodiments, the cooling element can comprise an asymmetrically exhausted linear nozzle to provide asymmetrical gas flow. By providing an affirmative cooling process at the surface and a thermally insulating lower porous layer, the solidification front tilts toward a vertical thermal gradient rather than horizontal thermal gradient and also contributes to heat removal.

The use of a well-insulated hot wall chamber reduces thermal losses and energy consumption. The actual energy required for heating and solidification of the silicon film are relatively small. To advance a solidification front in a 30 micron thick silicon film at a rate of 10 cm/min requires the removal of heat at a rate of ˜1.85 W per cm of solidification front, or 185 W for a 1 meter wide sheet. The reverse is also true (i.e. 1.85 W needs to be added to silicon at 1410C to melt it). In a cold wall chamber, heater powers in the multiple kW can be used in a ZMR apparatus because significant heat is continually injected into the substrate/silicon structure to compensate for the radiative and convection losses to the cold chamber walls. In some embodiments, a hot wall chamber can have a wall temperature from about 900 degrees C. below the film melt temperature to about 2 degrees C. below the melt temperature, in further embodiments from about 600 degrees C. to about 10 degrees below the melt temperature, and in other embodiments from about 500 degrees C. to about 50 degrees C. below the film melt temperature. Thus, for a silicon film with a melt temperature of about 1410° C., the chamber walls can be from about 500° C. to about 1408° C., in further embodiments from about 800° C. to about 1400° C., and in other embodiments from about 900° C. to about 1350° C. A person of ordinary skill in the art will recognize that additional temperature ranges within the explicit ranges above are contemplated and are within the present disclosure.

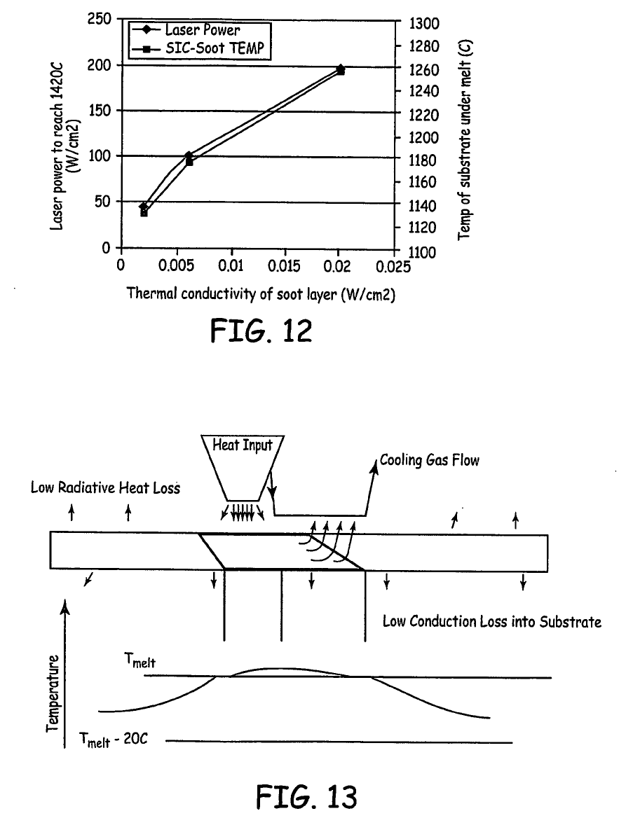

By providing the substrate with a porous layer, heat conductance is reduced into the substrate, which correspondingly reduces the energy expended in heating the substrate. To the extent that the silicon layer can be thermally isolated from the substrate, the substrate remains cooler and endures less thermal stress during ZMR. This is significant when utilizing re-usable substrates. Thus, since a molten zone is formed at 1410° C. for silicon, the lower the thermal conductivity between the molten zone and the substrate, the less energy is required to create the molten zone, and the less thermal stress is imparted on the substrate. FIG. 12 shows the theoretical influence of an insulative porous layer on the required light power to melt silicon and the temperature of the substrate below the melt zone for a cold wall chamber.

To dissipate the heat of solidification, controlled cooling through asymmetrical gas flow can be used. As mentioned above, the typical heat dissipation paths are reduced in a hot wall chamber. Radiative heat loss is proportional to ΔT⁴. There is a large difference in dissipated power between the melt zone (1410° C. for silicon) and a 200° C. surface as opposed to a 900° C. surface. In order to dissipate the heat of solidification, a stream of cool inert gas can be provided on the solidification side of the molten zone through an asymmetrically exhausted linear nozzle. The radiative energy heater to form the molten zone can be co-linear with a gas flow that impinges upon the substrate and is swept to the solidification side with a parallel exhaust nozzle. In other words, the cooling stream can be generated from a slit opening or the like that forms a sheet of cooling gas that impinges on the top surface of the silicon or cap layer along a stripe. The exhaust can be positioned to efficiently remove the cooling gas after it has reflected from the hot surface such that the cooling gas does not further cool the hot wall chamber. The temperature of the cooling gas can be selected to achieve the desired rate of cooling.

FIG. 13 shows a schematic temperature profile indicating the effects of heat flows for an embodiment with cooling gas to remove heat of solidification in a hot wall chamber. While using a vertical impingement of cooling gas to solidify the molten silicon, the horizontal thermal gradients in the silicon layer are low because radiative losses and conduction losses into the substrate are reduced. In FIG. 13, the cooling gas can flow according to the direction of the flow arrows marked as cooling gas flow in this particular embodiment. If the substrate is well insulated, then the substrate can be 100s degrees cooler than the melt zone. In contrast with approaches in which the film is not thermally insulated form the substrate, the film is not necessarily cooled to a temperature well below the melting point since the substrate does not conduct heat away from the film.

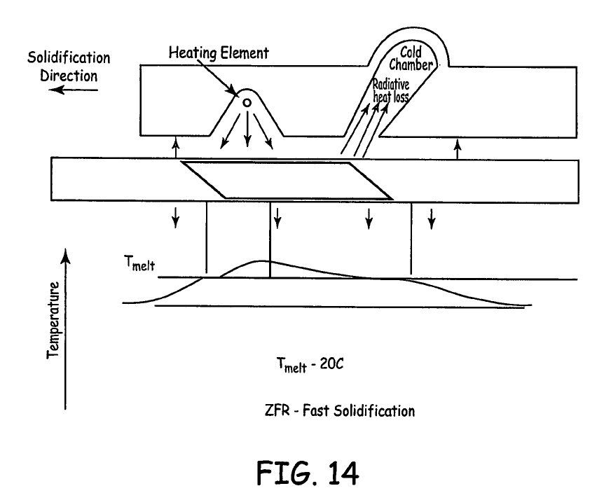

In alternative or additional embodiments, the cooling element can comprise a radiative cooling heat sink that is oriented to cool the film without removing excessive heat from the chamber. FIG. 14 shows a schematic temperature profile for a system with a heat sink to cool the melted film. The profile is similar to the profile in FIG. 13. In some embodiments, both cooling gas and a radiative cooling heat sink can be used to provide a desired level of cooling.

Through increased control of the solidification process, energy consumption can be reduced. First, by insulating the substrate from the molten film, the substrate is not heated to the film melting temperature, and correspondingly this heat from the substrate does not need to be removed for subsequent processing. The use of a cooling element can quickly remove most or all of the heat of melting along the surface. With respect to removing the heat of melting from the lower sections of the molten film, e.g., silicon, in a 30 micron film, conducting 1.85 W can involve a vertical temperature gradient below 10C per micron. If the solidification front tilts for more vertical thermal gradients by providing top gas cooling and porous insulating layer underneath the silicon layer as discussed above, only a fraction of the 1.85 W is removed by conduction from the lower portions of the layer to the cooled surface, which can slowly dissipate this small amount of heat through conventional dissipation paths. With a tilted solidification front, the amount of heat to be removed through conduction along a thermal gradient is reduced proportionally to the angle of the solidification front, such that this cooling can take place quickly without needing a large thermal gradient. Measuring the angle from vertical, the cooling conducted upward through the solidification front is reduced at least by 1.85 W×cosine of the angle. Due to the ability to remove the modest amounts of heat effectively with lower thermal gradients allows the structure to need less overall cooling downstream of the melting zone so that the chamber can be maintained at an overall higher temperature, which correspondingly provides for the need to supply less heat to melt the film in the melting zone.

ZMR Integration with Film Production and with Solar Cell Production

As noted above, various reactive flow processes are suitable for the formation of the inorganic films that are then subsequently recrystallized. Furthermore, the recrystallized films can then be further processed into ultimate products. One or more additional processing steps can be integrated together in a production line. This integration can result in additional energy savings for certain combinations as well as other potential processing efficiencies. However, in some embodiments, portions of the processing can be performed at remote locations.

Specifically, it can be advantageous to perform the film formation and the ZMR processing in-line. The substrates generally come out form the film formation step at significantly elevated temperatures. If the substrates from the film formation are transferred to the ZMR apparatus without significant heat loss, the substrates remove less heat, or possibly no heat, from a hot wall ZMR chamber when they structure is brought into the ZMR chamber. This can result in very significant energy savings. Suitable substrate handling equipment in the art can automate the substrate transfer between the units, and the substrate handling equipment can be appropriately insulated.

Subsequent to the recrystallization process, for embodiments based on a release layer, it is generally desirable to separate the recrystallized film from the substrate. The substrate can then be appropriately cleaned and/or polished for reuse. Some approaches for handling the released inorganic foil and for performing the separation process are described further in copending provisional patent application serial number 61/062,399, filed Jan. 25, 2008 to Mosso et al., entitled “Layer Transfer for Large Area Inorganic Foils,” incorporated herein by reference.

The resulting inorganic foils can be effectively incorporated for various applications, such as display controls. Photovoltaic panels are an area in which the films have a particular interest. The processing of silicon foils into solar cells is described further in copending U.S. patent application Ser. No. 12/070,371 to Heislmair, entitled “Solar Cell Structures, Photovoltaic Panels and Corresponding Processes, and in copending U.S. patent application Ser. No. 12/070,381 to Heislmair, entitled “Dynamic Design of Solar Cell Structures, Photovoltaic Panels and Corresponding Processes,” both of which are incorporated herein by reference. Specifically, these copending patent applications further describe the formation of photovoltaics from thin silicon sheets separated from an underlying porous release layer, and these approaches can be adapted for the thin silicon sheets formed by the methods described herein. One or more of the device processing steps can be incorporated into an in-line procedure downstream from the ZMR apparatus, and the in-line procedure can produce final photovoltaic panels in some embodiments.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What we claim is:

1. An apparatus for performing zone melt recrystallization of a inorganic film, the apparatus comprising a substrate support, a strip heater oriented to heat a stripe of a substrate on the substrate support, a cooling element that is oriented to cool a stripe of the substrate following heating by the strip heater, and a transport system configured to move the substrate support relative to the strip heater and the cooling element to scan a heated stripe across the substrate with subsequent cooling by the cooling element.

2. The apparatus of claim 1 wherein the strip heater comprises a halogen lamp, a xenon lamp, an inductive heater, or a carbon strip heater.

3. The apparatus of claim 1 wherein the strip heater comprises a diode array.

4. The apparatus of claim 1 wherein the cooling element comprises a cooling gas nozzle.

5. The apparatus of claim 1 wherein the cooling element comprises a heat sink radiation absorber.

6. The apparatus of claim 1 further comprising a chamber enclosing the strip heater and cooling element.

7. The apparatus of claim 6 wherein the chamber walls are insulated, heated or both insulated and heated.

8. The apparatus of claim 7 wherein the chamber walls are maintained with a selected temperature range.

9. The apparatus of claim 1 wherein the inorganic film comprises elemental silicon/germanium with an average thickness from about 3 microns to about 90 microns.

10. The apparatus of claim 1 wherein the transport system moves the substrate at a rate from about 0.5 mm/sec to about 10 mm/sec.

11. The apparatus of claim 1 further comprising an optical detector configured to measure the temperature of the film optically between the strip heater and the cooling element.

12. An apparatus for performing zone melt recrystallization of an inorganic film, the apparatus comprising a chamber, a substrate holder within the chamber, a strip heater oriented to direct heat along a stripe of a substrate mounted on the substrate holder, and a transport system configured to move the substrate support relative to the strip heater to scan a heated stripe across the substrate surface, wherein the chamber walls are maintained a temperature of at least about 500° C.

13. The apparatus of claim 12 wherein the selected temperature range is from about 2° C. to about 900° C. below the melting temperature of the inorganic film.

14. The apparatus of claim 13 wherein the inorganic film comprises elemental silicon/germanium with an average thickness from about 3 microns to about 90 microns.

15. The apparatus of claim 12 wherein the transport system moves the substrate at a rate from about 0.5 mm/sec to about 10 mm/sec.

16. The apparatus of claim 12 wherein the chamber walls comprise a refractory material.

17. A method for performing zone melt recrystallization of an inorganic film, the method comprising:
melting a stripe of the inorganic film using a strip heater wherein the inorganic film is located on a substrate being translated relative to the strip heater; and
cooling the melted film to a selected temperature below the melting point of the inorganic film downstream a distance from the heating zone following translation of the substrate.

18. The method of claim 17 wherein the substrate is translated past the strip heater at a rate from about 0.5 mm/sec to about 10 mm/sec.

19. The method of claim 17 wherein the inorganic film comprises elemental silicon/germanium with an average thickness from about 3 microns to about 90 microns.

20. The method of claim 19 wherein the elemental silicon/germanium film is on top of a porous particulate release layer, and wherein the release layer is supported on a support substrate.

21. The method of claim 20 wherein a ceramic under-layer with a thickness of about 100 nm to about 10 microns is located between the release layer and the silicon/germanium film, and wherein the ceramic under-layer comprises silicon/germanium oxide, silicon/germanium nitride, silicon/germanium oxynitride, silicon/germanium enriched forms thereof or combinations thereof.

22. The method of claim 20 wherein a ceramic capping layer is located over the elemental silicon/germanium film, the capping layer having a thickness from about 20 nm to about 5 microns and wherein the capping layer comprises aluminum oxide, silicon/germanium oxide, silicon/germanium nitride, silicon/germanium oxynitride, silicon/germanium enriched forms thereof or combinations thereof.

23. The method of claim 20 wherein the film comprises silicon and wherein the chamber temperature is from about 2° C. to about 900° C. below the melting temperature of the elemental silicon film.

24. The method of claim 20 wherein the degree of cooling is selected to remove the latent heat for solidification of the inorganic film in a selected period of time.

25. The method of claim 17 wherein the rate of translation of the inorganic film, the position of the cooling step and the degree of cooling are selected to yield a product polycrystalline film with a desired upper limit of crystal defect densities.
